(19) United States
(12) Patent Application Publication
(10) Pub. No.: US 2018/0305220 A1
(43) Pub. Date: Oct. 25, 2018

(54) PRESSURE VESSEL FOR WATER TREATMENT SYSTEM

(71) Applicant: Access Business Group International LLC, Ada, MI (US)

(72) Inventors: Michael E. Miles, Grand Rapids, MI (US); Terry L. Lautzenheiser, Nunica, MI (US); Robert Wolford, Rockford, MI (US)

(21) Appl. No.: 15/956,892

(22) Filed: Apr. 19, 2018

Related U.S. Application Data
(60) Provisional application No. 62/487,643, filed on Apr. 20, 2017.

(51) Int. Cl. C02F 1/00; E03B 1/04; E03C 1/04

(52) U.S. Cl. CPC C02F 1/003; E03B 1/04; E03C 1/041; B01D 2201/4053; C02F 2201/005; C02F 2201/004; B01D 2201/4023; E03C 2201/40

(57) ABSTRACT

A pressure vessel having an outer shell and a flexible inner liner. The outer shell and inner liner are configured so that the water passing through the water treatment system engages the inner liner, and not the outer shell. The inner liner is blow molded from a material that does not leach undesirable substances into the water flowing through the water treatment systems. The inner liner may include a receptacle portion to house one or more water treatment components. The receptacle portion may be flexible under the anticipated range of internal pressures. The receptacle portion may be disposed in the outer shell with the outer shell concealing expansion/contraction of the inner liner and providing the pressure vessel dimensional stability. The inner liner may include a rigid neck portion mounted to the outer shell. The outer shell and/or inner liner may include internal ribs configured to maintain spacing therebetween.

### BACKGROUND OF THE INVENTION

The present invention relates to water treatment systems, and more particularly to pressure vessels for point-of-use water treatment systems.

Water treatment systems are widely used to improve water for human consumption. In a typical point-of-use water treatment system, the water treatment system is connected to a pressurized supply of untreated water, for example, to a pressurized supply of water provided by a municipality or to a pressure tank containing water drawn from a private well. With conventional water treatment systems, the pressure in the water supply is used to move water through the water treatment components housed within the system. This means that a conventional water treatment system must be capable of withstanding supply-line pressure. With many water treatment systems, the water treatment device (e.g. a filter, ultraviolet light source and/or other water treatment device) is situated in a pressure vessel with sufficient rigidity to withstand the internal pressure. The pressure vessel defines a portion of the water flow path and has sufficient inherent structural integrity to directly withstand line pressure. Because the pressure vessel is in direct contact with the water passing through the water treatment system, it must be manufactured from special materials that are verified not to leach undesirable substances into the water. Materials of this nature are relatively expensive. As a result, conventional pressure vessels manufactured from non-leaching materials appropriate for use in water treatment systems are relatively expensive.

### SUMMARY OF THE INVENTION

The present invention provides a pressure vessel having an outer shell and a flexible inner liner. The outer shell is configured to support the inner liner. The outer shell and inner liner are configured so that the water passing through the water treatment system engages the inner liner, and not the outer shell. The inner liner is blow molded from a material that does not leach undesirable substances into the water flowing through the water treatment systems. Because the outer shell is not in contact with the water, it is not necessary to manufacture the outer shell from a material that does not leach. As a result, the outer shell can be manufactured from less expensive material than is used to manufacture the inner liner.

In one embodiment, the inner liner includes a flexible receptacle portion. The receptacle portion may define an internal space to house one or more water treatment components, such as a carbon block filter for removing particulate matter and/or an ultraviolet light for disabling microorganisms. The receptacle portion may be configured to be flexible under the anticipated range of internal pressures. As a result of its flexibility, the receptacle portion helps to buffer pressure surges in the water supply. The flexible receptacle may be disposed within the outer shell so that expansion and contraction of the receptacle portion is not visible to the consumer and the outer shell provides dimensional stability despite variation in the dimensions of the receptacle portion.

In one embodiment, inner liner includes a rigid neck portion. The neck portion of the inner liner may be configured to be secured to the outer shell and to interface with a closing structure. For example, the pressure vessel may be closed by a manifold having an inlet through which water can be introduced into the pressure vessel for treatment and an outlet through which treated water can be returned from the pressure vessel. In such embodiments, the neck portion of the inner liner may include a closure system that allows the manifold to be closed onto the pressure vessel. For example, the neck portion of the inner liner may include one or more threads or other features that are capable of interconnecting with the manifold. In embodiments of this type, the neck portion of the inner liner may be configured with sufficient structural integrity to withstand the forces associated with the closure system without reinforcement from the outer shell. This may be achieved by forming the inner liner blank with the desired mouth and limiting the blow molding process to the receptacle portion of inner liner blank.

In one embodiment, the outer shell is pre-manufactured and the inner liner is blow molded into place within the outer shell. The inner liner may be manufactured from an inner liner preform (or blank) that is injection molded from PET, PETG or other materials having acceptable non-leaching characteristics. The injection molded preform or blank may then be blow molded to form the inner liner. For example, the inner liner blank may be situated inside the outer shell and then blow molded outwardly and downwardly in a generally conventionally manner using conventional blow molding techniques and apparatus. The inner liner may be configured to engage and possibly mechanically interlock with the outer shell as it is blow molded into its final shape. Additionally or alternatively, the inner liner may be cemented, heat welded, mechanically interlocked or otherwise interconnected with the outer shell.

In one embodiment, the inner liner is, at ambient pressure, spaced apart from the outer shell so that the inner liner can expand under pressure into the space provided by the outer shell. To facilitate manufacture, the outer shell may include one or more features on its inner surface to maintain the desired gap between the inner liner and the outer shell. For example, the outer shell may include a plurality of ribs extending inwardly from the inner surface of the outer shell toward the inner liner. The ribs may be spaced apart so that the inner liner can expand into the spaces therebetween.

In one embodiment, the outer shell is manufactured from an engineered plastic of sufficient strength to reinforce the inner liner without regard to the material's propensity to leach into water. For example, the outer shell may be injection molded from acrylonitrile styrene acrylate, acrylonitrile butadiene styrene or polycarbonate. The outer shell may alternatively be formed from essentially any suitable material using essentially any manufacturing techniques appropriate for that material.

In one embodiment, the outer shell and inner liner are spaced apart to define an enclosed internal space therebetween. The internal space may be evacuated (partially evacuated) to provide the pressure vessel with improved insulating properties. In one embodiment, the blow molding process may inherently create the vacuum in the internal space. For example, the blow molding process may involve the use of negative pressure outside of the inner liner blank.

In one embodiment, the pressure vessel includes a closed outer shell. In such embodiments, it may be desirable to add a vent or valve to the outer shell so that air is free to escape from between the outer shell and inner liner as the inner liner is blow molded into its final shape. The escape of air may be the result of expansion of the inner liner and/or heating of the air. For example, when a one-way valve is provided, the internal air pressure is increased by the heat used during the blow molding process. When blow molding is complete, the air remaining in the interior will cool resulting in a partial vacuum. This can be supplemented by applying a vacuum source to the vent or valve so that air can be drawn from the space between the outer shell and the inner liner to enhance the partial vacuum.

In one embodiment, the vent may include one or more openings in the outer shell. In such embodiment, the opening(s) may be configured so that they are closed by the expansion of the inner liner into its final shape. For example, the expanding inner liner may cover and seal the opening(s) so that the internal space is enclosed in the finished pressure vessel.

In one embodiment, the bottom of the inner liner may be shaped to provide a fixed base configured to support an internal water treat component, such as an activated carbon filter. In one embodiment, the base includes a plurality of contours that cooperative form a support surface of the water treatment component. For example, the bottom of the inner liner may be formed into a petaloid shape akin to the bottom of a plastic soft drink, or water, bottle. The top surfaces of the petaloid elements may be generally planar and may cooperatively define the base. Additionally, the contours may help to strengthen the inner liner. In one embodiment, the contours in the base are configured to interfit with corresponding contours in the outer shell. In one embodiment, the outer shell may have a plurality of radially extend support ribs that are arrange in radially-spaced groups corresponding to the shape of the bottom of the inner liner. The petaloid contours may be formed to extend into the spaces between the radially-spaced groups.

In one embodiment, the pressure vessel includes an open outer shell that causes the space between the inner liner and the outer shell to remain in communication with the external environment. For example, the bottom of the outer shell may be generally open so that space between the inner liner and the outer shell is not enclosed. This may be particularly useful when the inner liner is blow molded using positive pressure applied on the inside of the inner liner blank. To prevent the inner liner from being forced through any opening in the outer shell, the manufacturing process may include a mandrel that extends into the opening(s). For example, in one embodiment, the bottom of the outer shell may be open, except for the radially extending support ribs and the mandrel may be essentially the reverse of the support ribs so that it can be fitted into the bottom of the outer shell in the spaces between the support ribs.

The present invention provides a simple and effective pressure vessel construction that is strong, yet inexpensive. The use of an inner liner eliminates the need for the entire pressure vessel to be manufactured from a more expensive material verified to meet applicable non-leaching standard. The outer shell provides dimensional stability for the flexible inner liner, which may expand under pressure. The outer shell may also provide additional hoop strength. If desired, the outer shell and the inner liner can be spaced apart to create an internal space that improves the insulating properties of the pressure vessel. If desired, the outer shell may include openings that allow air to vent from the space between the inner liner and the outer shell as the inner liner expands during manufacture. The use of a one-way valve may allow the interior space to vent during blow molding and result in a partial vacuum in the finished product.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 is a perspective view of a pressure vessel in accordance with an embodiment of the present invention.

FIG. 2 is a sectional view of an assembled inner liner and outer shell.

FIG. 3 is an exploded top perspective sectional view of the pressure vessel.

FIG. 4 is an exploded bottom perspective sectional view of the pressure vessel.

FIG. 5 is a perspective view of the outer shell.

FIG. 6 is a top plan view of the outer shell.

FIG. 7 is a bottom plan view of the outer shell.

FIG. 8 is a perspective sectional view of the outer shell.

FIG. 9 is a perspective view of the inner liner.

FIG. 10 is a front view of the inner liner.

FIG. 11 is a top plan view of the inner liner.

FIG. 12 is a bottom plan view of the inner liner.

FIG. 13 is a perspective sectional view of the inner liner.

FIG. 14 is a sectional view of an alternative pressure vessel.

FIG. 15 is a perspective partially sectional view of the alternative pressure vessel.

FIG. 16 is a perspective partially sectional view of the pressure vessel containing an exemplary water treatment assembly.

FIG. 17 is a perspective partially sectional view of a molding fixture with a mandrel configured for use in blow molding the inner liner.

### DESCRIPTION OF THE CURRENT EMBODIMENT

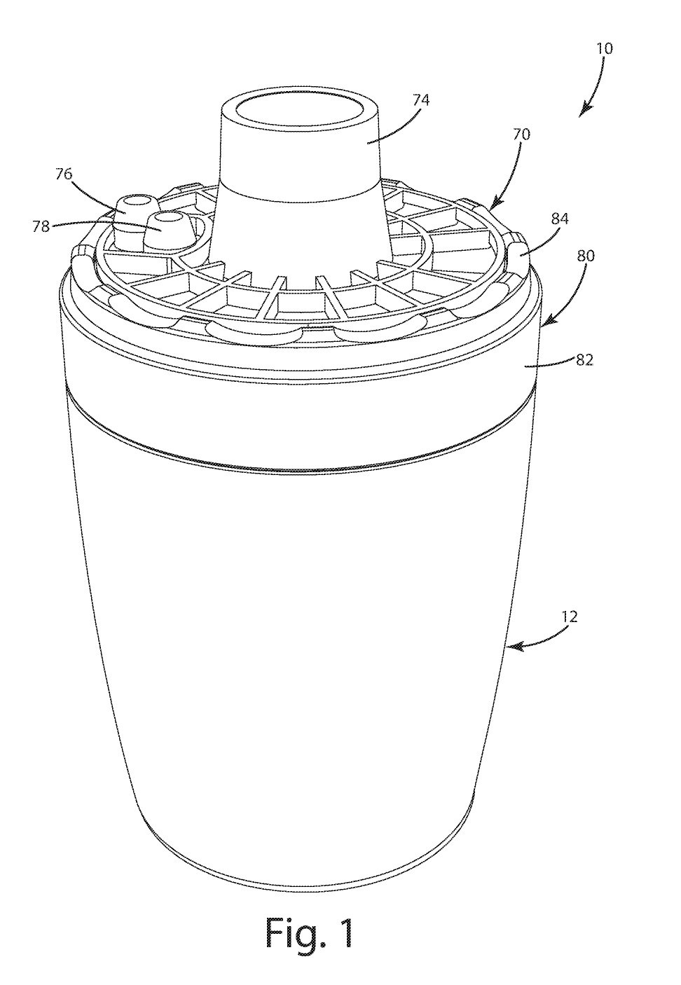

A pressure vessel 10 in accordance with an embodiment of the present invention is shown in FIG. 1. The pressure vessel 10 is intended for use in a water treatment system (not shown) and generally includes an outer shell 12 and an inner liner 14 that are joined together to form the completed vessel. The inner liner 14 may be closed by a manifold 70 and a locking ring 80. The inner liner 14 is manufactured from a material that meets applicable non-leaching requirements. The inner liner 14 is configured to be flexible so that it can expand somewhat under pressure. The outer shell 12 is configured to receive and provide supplemental structural support for the inner liner 14 to withstand the internal pressures encountered during use of the water treatment system. The pressure vessel 10 may be configured with a space between the inner liner 14 and the outer shell 12. The space may be enclosed to provide improved insulating properties. If desired, the internal space may be under partial vacuum to provide enhanced insulation. The inner liner 14 and outer shell 12 may be provided with contours that help to maintain the desired spacing. For example, the outer shell 12 may include a plurality of annular ribs 16a-d extending inwardly toward the inner liner 14. The bottom of the inner liner 14 may include a plurality of contours that cooperatively provide a base 18 for supporting a water treatment component, such as an activated carbon filter.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

Pressure vessels are typically used in a water treatment system to house water treatment components and to define a portion of the water flow path through the water treatment system. More specifically, the pressure vessel may define an enclosed space configured to receive one or more water treatment components, as well as a portion of the inlet flow path that routes untreated water to the water treatment component(s) and/or a portion of the outlet flow path that routes treated water away from the water treatment component(s). The present invention is capable of use in a wide range of point-of-use water treatment systems that incorporate a pressure vessel. For example, pressure vessels configured in accordance with the present invention may be incorporated in the water treatment system shown in US Pub. No. US2016/0340202 to Lautzenheiser et al, which was filed on May 20, 2016, (U.S. Ser. No. 15/160,151) and is incorporated herein by reference in its entirety. The pressure vessel may vary in size, shape and other characteristics to allow it to be used in a variety of alternative applications. The pressure vessel is generally configured to house one or more water treatment components (not shown), such as a particulate filter, an activated carbon filter and/or an ultraviolet lamp. It should be understood that these particular water treatment components are merely exemplary, and that the present invention may be used with a wide range of additional or alternative water treatment components.

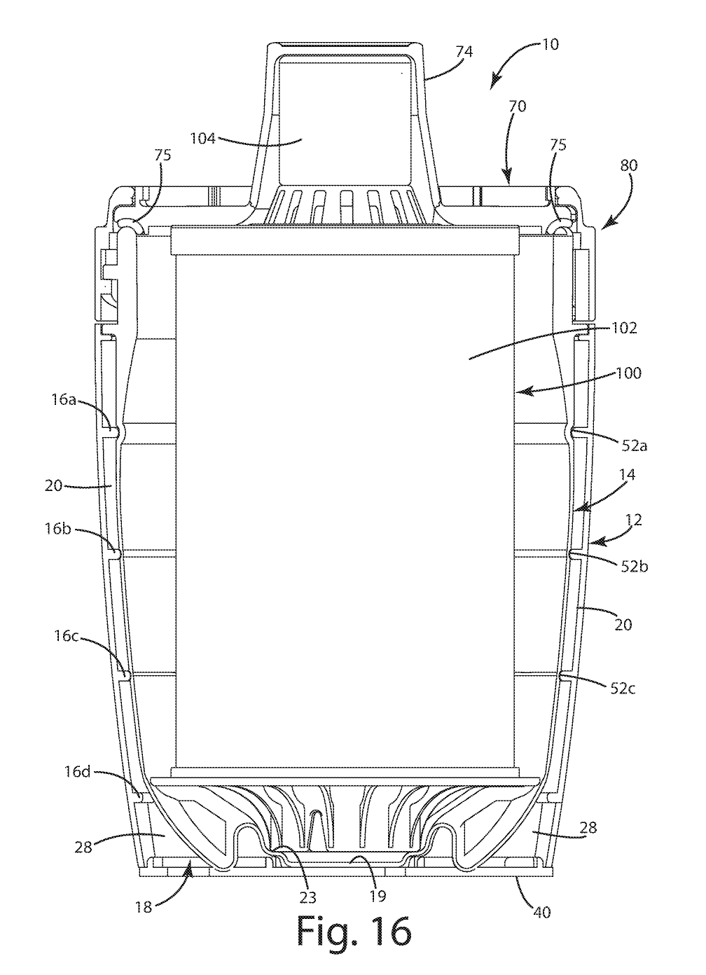

As noted above, the pressure vessel 10 of FIG. 1 generally includes an outer shell 12 and inner liner 14 that are joined to one another. The outer shell 12 is configured to receive the inner liner 14 and may be manufactured from essentially any material capable of satisfying the applicable strength concerns. In the illustrated embodiment, the outer shell 12 is a generally cylindrical container defining an interior space 20 of sufficient size to receive and contain the inner liner 14. The size, shape and configuration of the outer shell 12 may vary from application to application. For example, the outer shell 12 need not be circular in cross-section, but may instead have essentially any desired cross-sectional shape as may be dictated by the form or function of the water treatment component(s) to be housed within the pressure vessel 10 and/or the form or function of the water treatment system in which the pressure vessel 10 will be incorporated. In the illustrated embodiment, the pressure vessel 10 is configured to house a water treatment assembly 100 (See FIG. 16) including a carbon block filter 102 and a UV lamp 104, such as the water treatment assembly shown and described in US Pub. No. US2016/0340202 (U.S. Ser. No. 15/160,151), which as noted above is incorporated herein by reference in its entirety. In this embodiment, the carbon block filter 102 is generally ring-shaped and the UV lamp 104 is configured to extend through the interior of the carbon block filter 102. The water treatment assembly 100 of FIG. 16 includes a contoured bottom 106 that is configured to seat in the contoured base 18 of the inner liner 14. The bottom 18 may be manufactured from a material that is sufficiently resilient to provide a leaktight seal when compressed against the raised shoulder 23 by the manifold 70. As shown in FIG. 16, the bottom 18 may engage the raised shoulder 23 surrounding the planar section 19. In use, water enters the pressure vessel 10 through a water inlet 76 in the manifold 70 and is routed along the interior of the pressure vessel 10 to the exterior of the carbon block filter 102. Water then flows radially inward through the carbon block filter 102. After traveling through the carbon block filter 102, the water is routed to a location near one end of the UV lamp 104 (e.g. the bottom end in this embodiment). The water flows along the length of the UV lamp 104, where it is subjected to UV light. The water is then routed back to the manifold 70 where it exits the pressure vessel 10 via the water outlet 78.

In the illustrated embodiment, the outer shell 12 defines a top opening 22 through which the inner liner 14 is fitted into the interior space 20. The outer shell 12 may include a shoulder 24 configured to receive and support the inner liner 14. In the illustrated embodiment, the shoulder 24 is formed by an inwardly extending annular protrusion. In some applications, the shoulder 24 may be formed by other structure or may be eliminated. For example, in some applications, the inner liner 14 may engage the top surface of the outer shell 12 rather than a shoulder 24 formed separately from the top surface. The size, shape and configuration of the top opening 22 may vary from application to application.

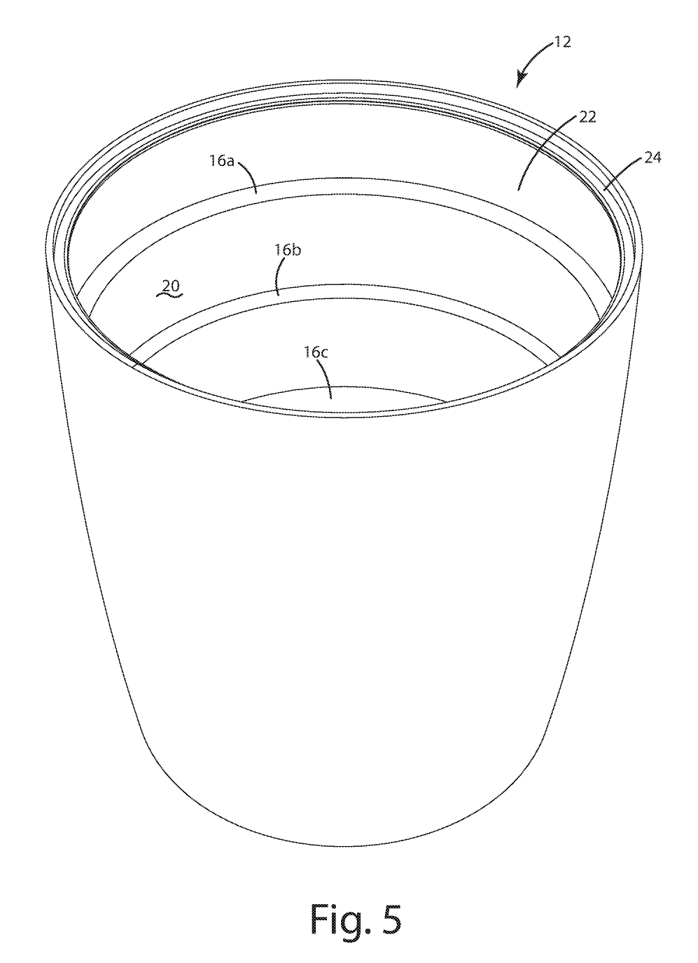

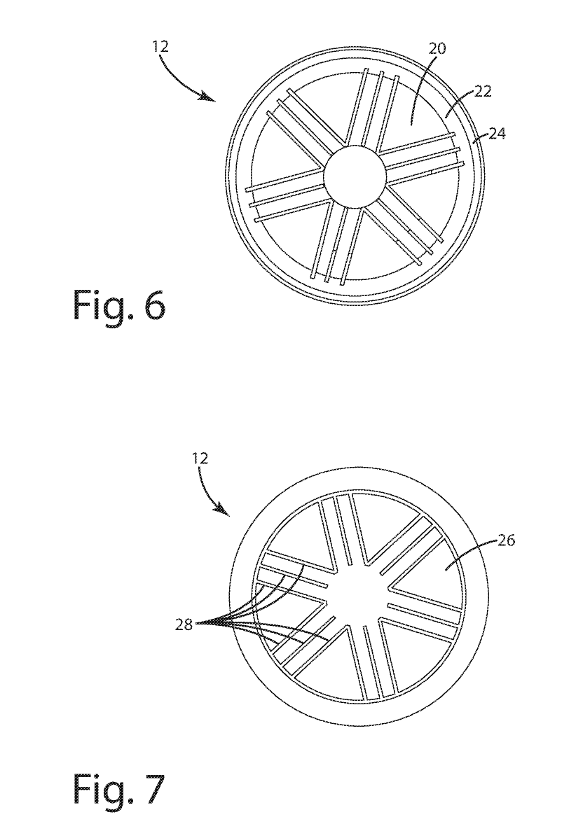

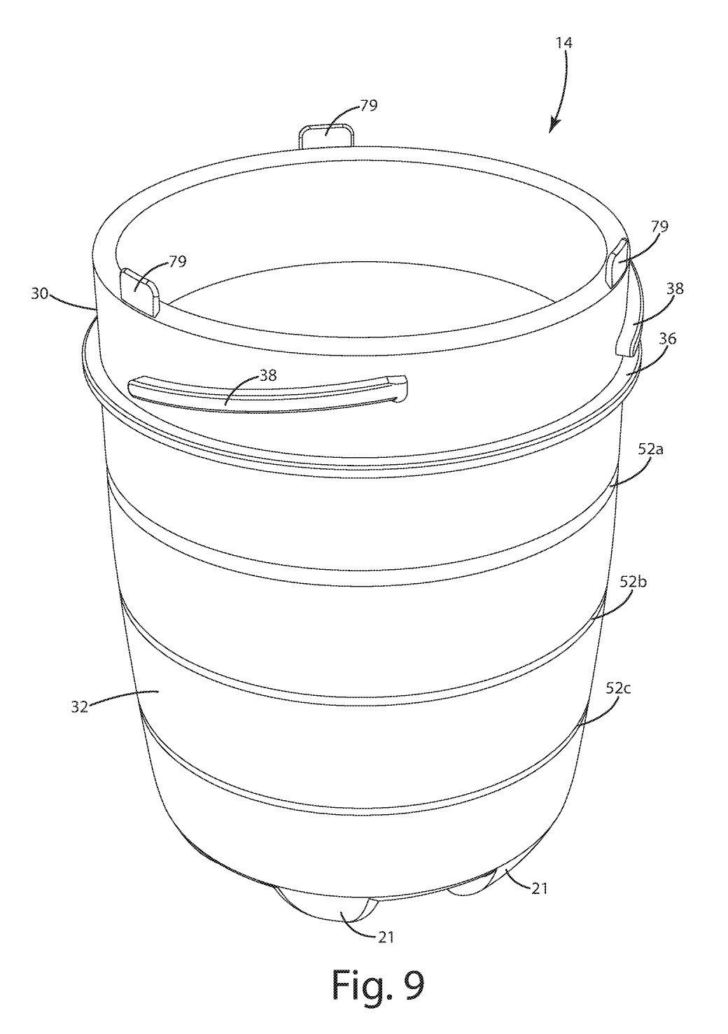

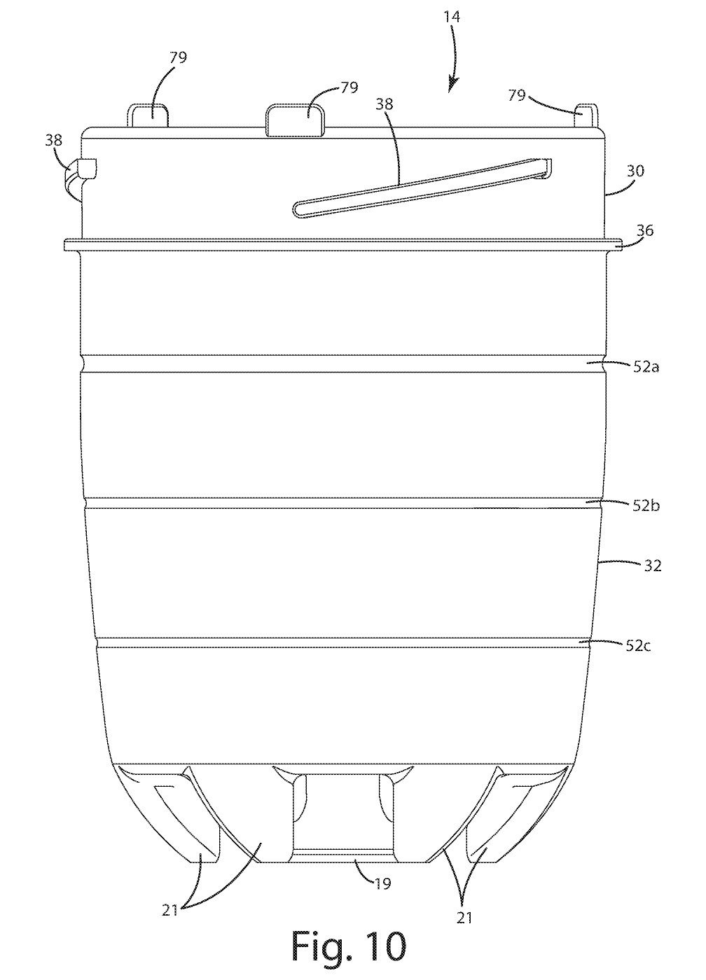

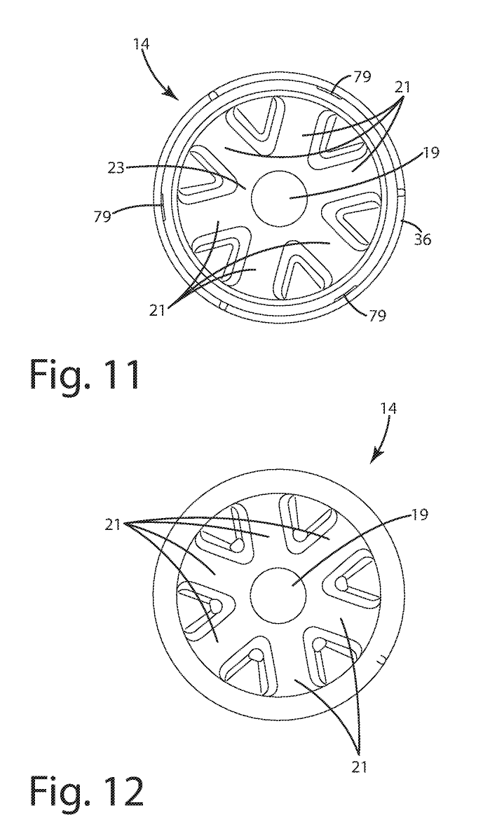

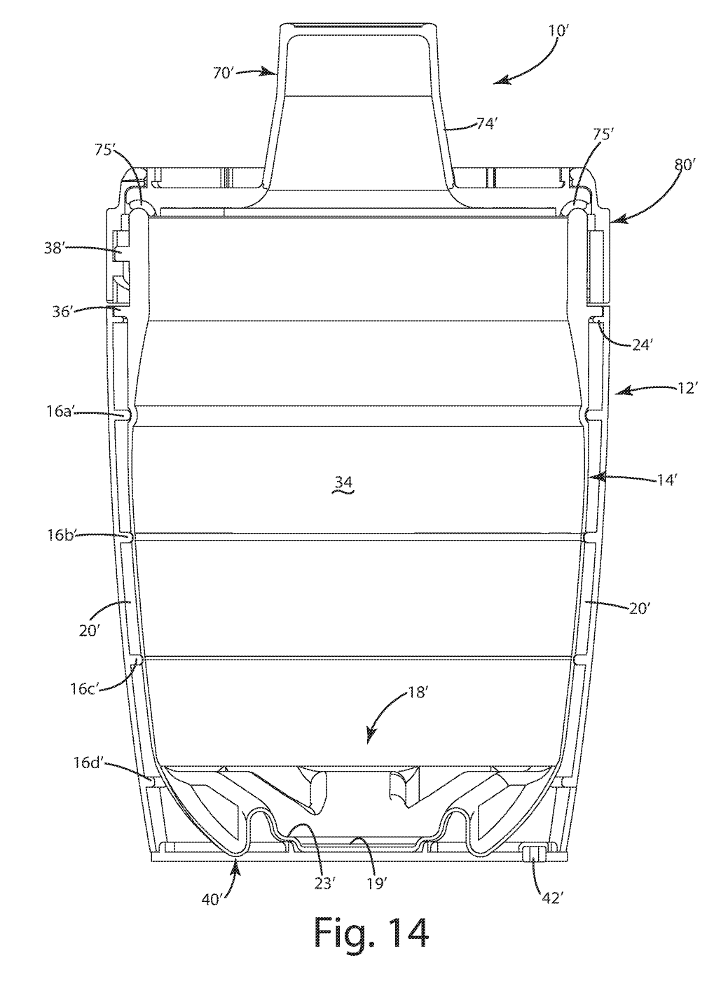

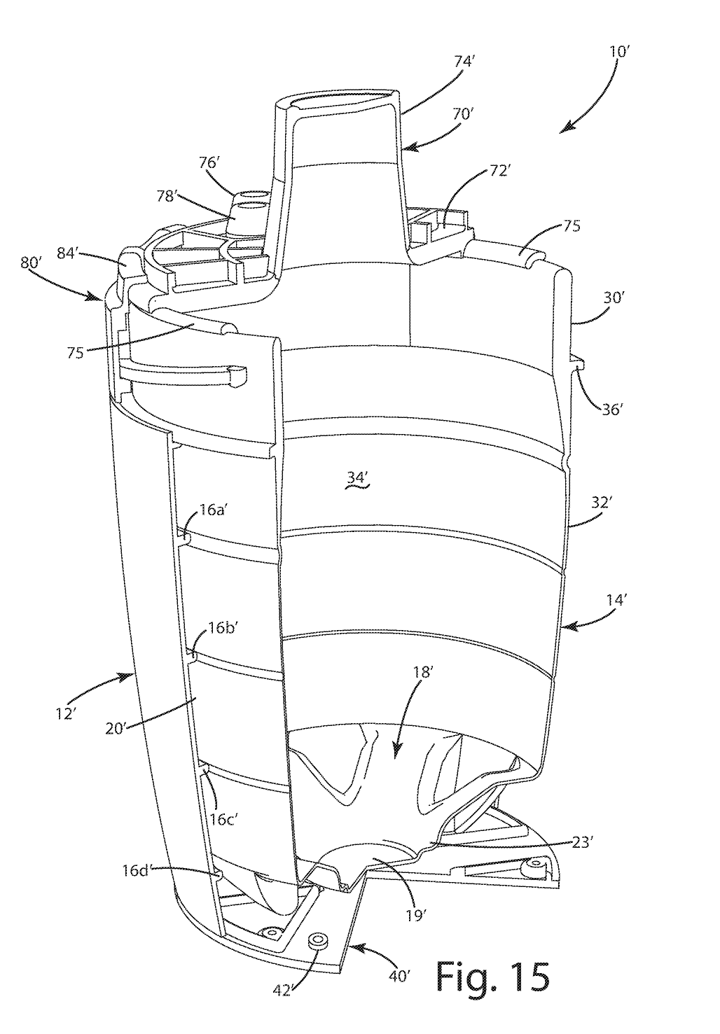

The outer shell 12 of FIGS. 1-13 also defines a bottom opening 26. In applications in which the inner liner 14 is blow molded in place within the interior space 20 of the outer shell 12, the bottom opening 26 allows air to escape from the interior space 20. Although the bottom opening 26 of the illustrated embodiment includes the entire bottom of the outer shell 12, it may occupy only a portion of the bottom of the outer shell 12. For example, the bottom opening 26 may be an aperture of almost any size formed through the bottom of the outer shell 12. In the illustrated embodiment, the bottom opening 26 is closed by a bottom cover 40. The bottom cover 40 may be secured to the outer shell 12 using essentially any suitable mechanism, such as adhesive, cement, welding, friction, press fit, fasteners, etc. The bottom cover 40 may be installed before or after the inner liner 14 is secured to the outer shell 12. In applications in which the inner liner 14 is blow molded in place within the outer shell 12, the bottom cover 40 may be installed after blow molding so that air can escape the interior space 20 as the inner liner 14 expands. The bottom cover 40 may be installed before the inner liner 14 is blow molded in place within the outer shell 12, but it may be beneficial to provide a way for air to escape from the interior space 20. For example, as shown in the alternative embodiment of FIGS. 14-15, pressure vessel 10′ may include a bottom cover 40′ having an opening or a one-way valve 42′ that allows air to escape from the interior space 20′ as the inner liner 14′ expands within the outer shell 12′. When the bottom cover 40′ includes an opening (not shown), the opening may be closed, for example, by a plug or caulking, following blow molding of the inner liner 14′. When a one-way valve 42′ is provided, the valve 42′ will be configured to permit air to escape the interior space 20′ as the inner liner 14′ expands. The heat from the blow molding process may increase the air pressure within the space 20′ and lead to more air being expelled through the valve 42′. When blow molding is complete and the temperature drops, the remaining air within the space 20′ will cool resulting in lower air pressure within the now enclosed space 20′. This reduction in air pressure may cause the interior space 20′ to be under a partial vacuum and may provide improved insulating properties.

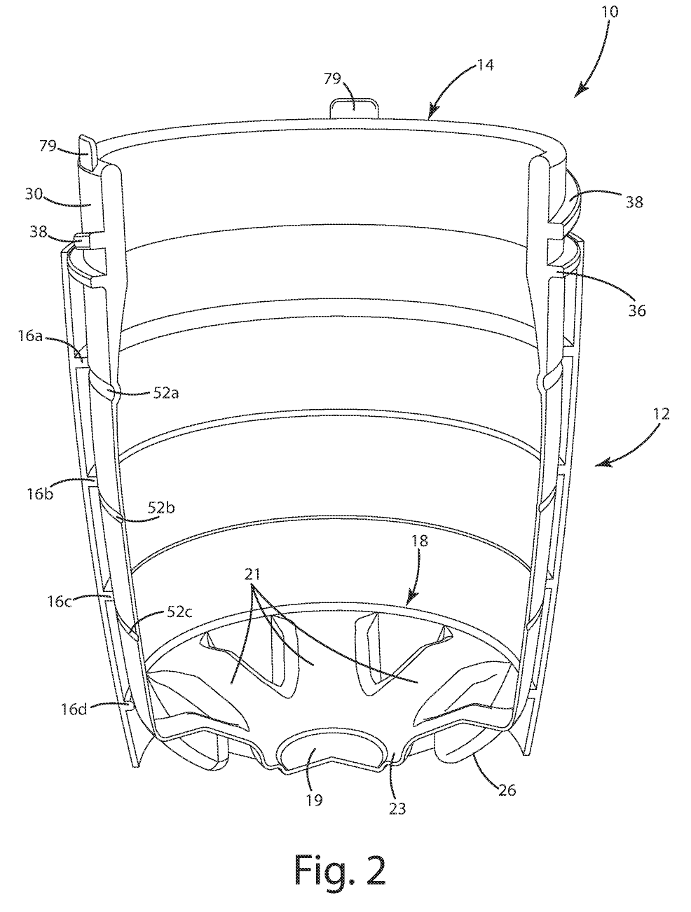

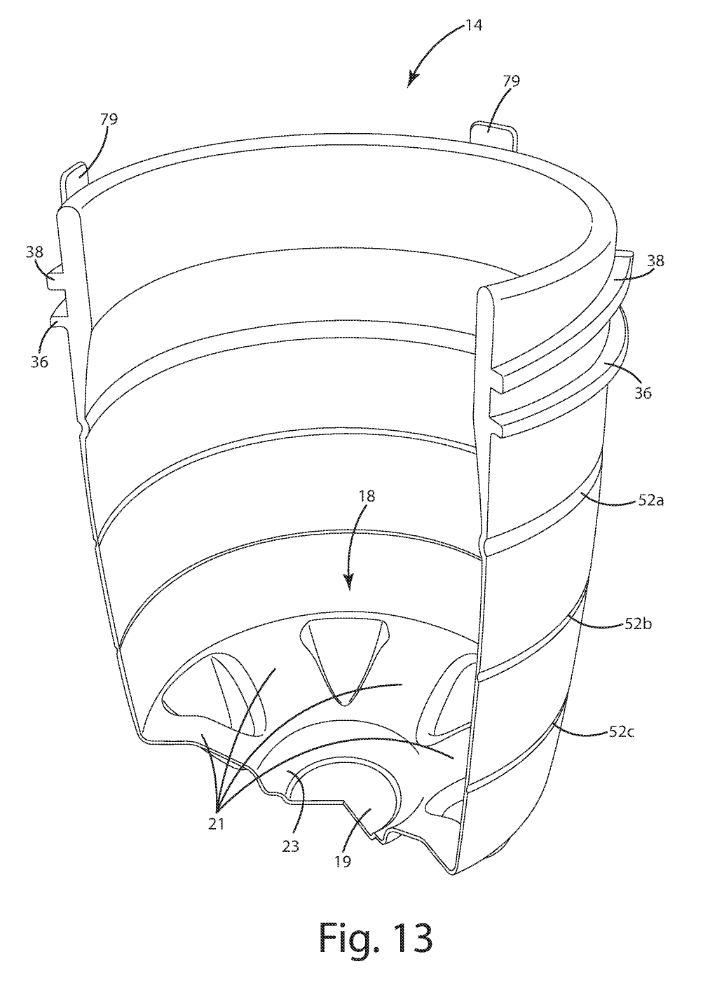

In the illustrated embodiment, the outer shell 12 includes a plurality of features intended, in part, to maintain spacing between the outer shell 12 and the inner liner 14. The outer shell 12 of the illustrated embodiment includes a plurality of inwardly extending ribs 16a-d. The ribs 16a-d of this embodiment extend circumferentially around the interior of the outer shell 12 through a generally horizontal plane. The number, size, shape and arrangement of ribs 16a-d may vary from application to application as desired. For example, the horizontal ribs 16a-d may be replaced by or supplemented with vertical ribs. In the illustrated embodiment, the inner ends of the ribs 16a-d are rounded to provide an improved interface with the inner liner 14. As perhaps best shown in FIG. 13, the inner liner 14 may include shallow channels 52a-c that align with some or all the ribs 16a-d. FIG. 2 shows a gap between most of the ribs 16a-d and the channels 52a-c. In some applications, this gap is closed (or partially closed) when the inner liner 14 flexes outwardly under internal water pressure. Alternatively, the outer shell 12 and inner liner 14 may be configured so that all of the ribs 16a-c and channels 52a-c are in contact even when the inner liner 14 is not under pressure. In some applications, the channels 52a-c may be formed as part of the blow molding process. For example, when the inner liner 14 is blow molded in place within the outer shell 12, the inner liner 14 may expand outwardly into contact with the ribs 16a-d so that physical interaction with the ribs 16a-d creates the channels 52a-c. In other applications, the inner liner 14 may be blow molded outside the outer shell in a mold cavity (not shown) that is shaped to impart the inner liner 14 with the channels 52a-c. In addition to helping maintain spacing between the outer shell 12 and the inner liner 14, the ribs 16a-d may also help to provide the outer shell 12 with additional strength. Further, when the inner liner 14 expands under pressure, it may swell into intimate contact with the ribs 16a-d. When this occurs, the ribs 16a-d may provide the inner liner 14 with additional hoop strength. With sufficient engagement between the inner liner 14 and the ribs 16a-d, the ribs 16a-d seal against the inner liner 14 and create isolated pockets of air, which may help to improve the insulating properties of the pressure vessel 10. In other applications, the spacing features may be eliminated. For example, the outer shell 12 and the inner liner 14 may be configured so that there is no space between them or the space may exist without the presence of any spacing features.

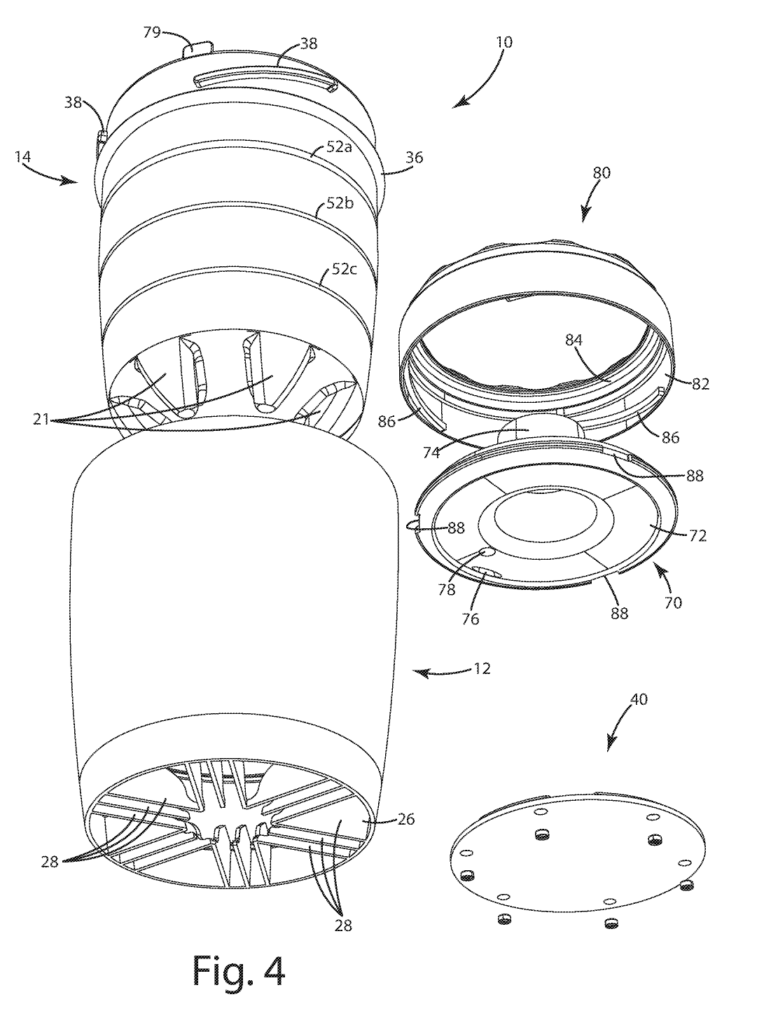

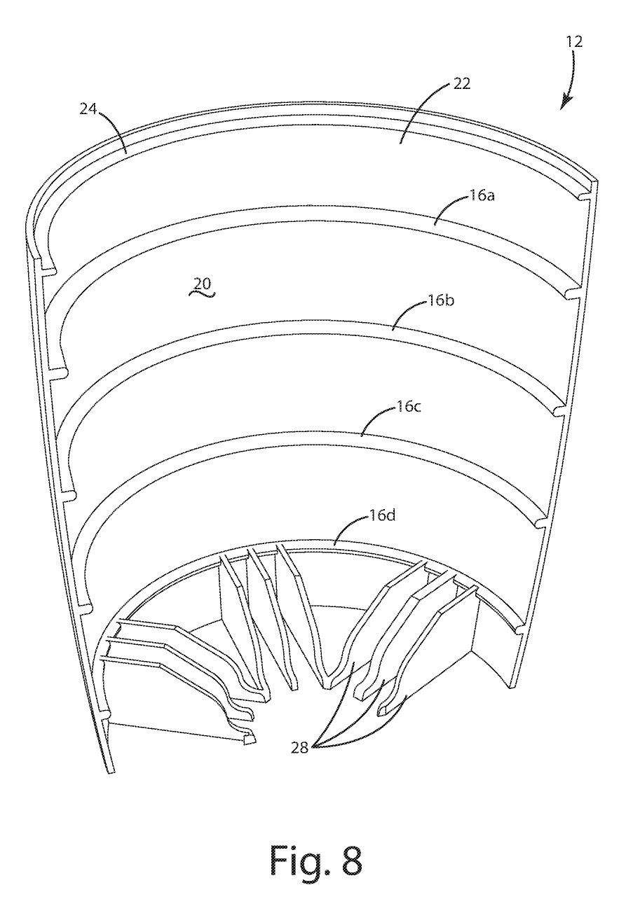

In the embodiment of FIGS. 1-13, the outer shell 12 includes internal features intended to support the bottom of the inner liner 14. More specifically, the outer shell 12 includes a plurality of radially extending support ribs 28 that are arrange in radially-spaced groups corresponding to the shape of the bottom of the inner liner (See FIGS. 4 and 8). In the illustrated embodiment, the bottom of the inner liner 14 has a petaloid shape with six lobes. To support this structure, the support ribs 28 are arranged in six groups that underlie the support portions of the base 18 and accommodate the lobes in the spaces between the radially-spaced groups of ribs 28. The support ribs 28 are configured to give the bottom of the inner liner 14 the desired petaloid shape in those applications in which the inner liner 14 is blow molded in place within the outer shell 12. The number, size, shape and configuration of support features may vary from application to application as desired. For example, the support features may be configured to correspond with inner liners 14 of alternatively shapes. In some applications, the support features may be eliminated. For example, FIGS. 14-15 show an alternative pressure vessel 10′ in which there are no support features in the outer shell 12′. In this embodiment, the planar central portion and undersurfaces of the lobes in the bottom of the inner liner 14′ directly engage the bottom cover 40′. Although not shown, the bottom cover 40′ may be contoured to correspond in shape with the bottom of the inner liner 14′, so that the bottom cover 40′ contacts the entire bottom of the liner 14.

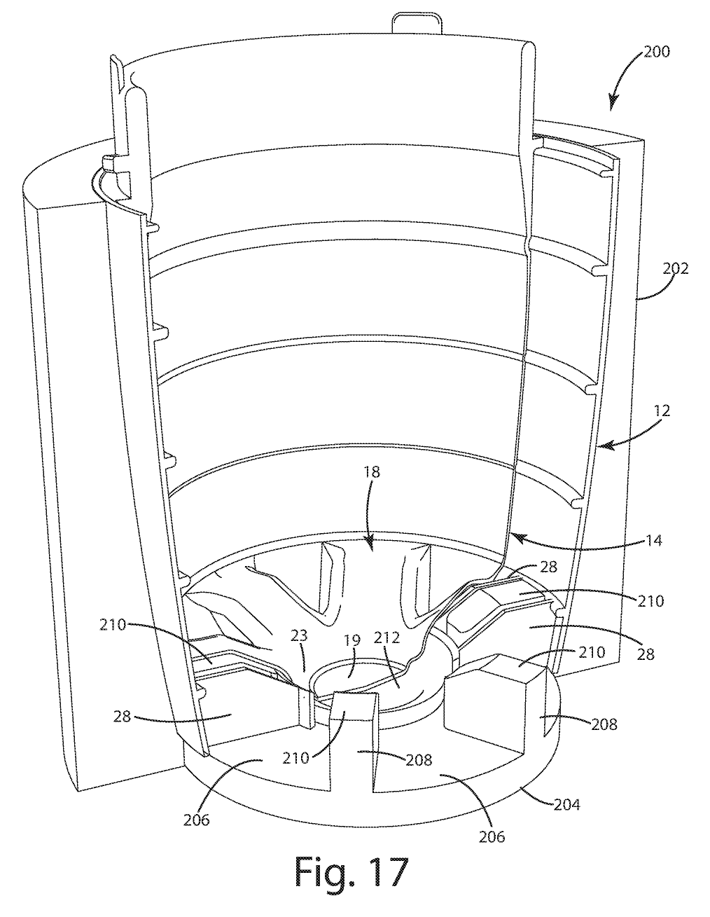

In some applications, it may be desirable to use a mandrel to assist in blow molding the inner liner 14, 14′ in place within the outer shell 12, 12′. For example, a mandrel may be fitted into the bottom of the outer shell 12, 12′ during blow molding to cooperate with the support features (e.g. support ribs 28) in forming the bottom of the inner liner 14 into the desired shape. To illustrate, FIG. 17 shows the outer shell 12 and inner liner 14 positioned in a molding fixing 200 generally including an outer shell mold part 202 and a mandrel 204. The outer shell mold part 202 defines a cavity configured to closely receive the outer shell 12. For example, the inner shape of the outer shell mold part 202 may correspond with the outer shape of the outer shell 12 so that the outer shell mold part 202 supports the outer shell 12 during blow molding of the inner liner 14. The size, shape and configured of the outer shell mold part 202 may vary from application to application. The mandrel 204 is configured to be fitted into the opening in the bottom of the outer shell 12 and is shaped to correspond with the bottom of the inner liner 14. When used in connection with outer shell 12, which has support features (e.g. support ribs 28), the mandrel 204 is configured to fit around the support features. In the illustrated embodiment, the mandrel 204 has a contoured surface that complements the shape of the bottom of the inner liner 14 and the bottom of the outer shell 12. The mandrel 204 of FIG. 17 generally includes an alternating arrangement of voids 206 and lugs 208 that are disposed about a central portion 212. The voids 206, lugs 208 and central portion 212 cooperatively form the supplemental surfaces against which the petaloid shape can be formed during blow molding. In this embodiment, the voids 206 are configured to extend through the spaces between the radially-spaced groups of support ribs 28 to receive the lobe-shaped contours 21 on the bottom of the inner liner 14. The lugs 208 are configured to extend inwardly through the outer shell 12 between each pair of adjacent support ribs 28 in each group. In the illustrated embodiment, the inner surface 210 of each lug 208 is configured to shape the inner liner 14. The central portion 212 is configured to receive and support the bottom central portion of the inner liner 14, including planar section 19 and shoulder 23. When used in connection with outer shell 12′, which does not have support features, the mandrel may be configured to fill the bottom of the outer shell 12′ and to provide a continuous contoured surface against which the entire petaloid shape is formed. The design and configuration of the mandrel may be selected to assist in providing essentially any desired shape to the bottom of the inner liner 14, 14′. Following the blow molding process, the mandrel is removed and the bottom cover may be installed to close the bottom of the outer shell 12, 12′.

In the illustrated embodiment, the outer shell 12 is injected molded from an engineered plastic, such as acrylonitrile styrene acrylate, acrylonitrile butadiene styrene or polycarbonate or other suitable materials. The outer shell 12 need not, however, be manufactured from moldable material, but may instead be manufactured from essentially any material capable of providing the desired structural characteristics using any suitable manufacturing methods. For example, the outer shell may alternatively be stamped or otherwise formed from a sheet material, such as steel or aluminum sheet metal.

As noted above, the inner liner 14 is affixed to and disposed within the outer shell 12. In the illustrated embodiment, the inner liner 14 includes a rigid neck portion 30 and a flexible receptacle portion 32. The neck portion 30 is configured to be secured to the outer shell 12 and to be closed by manifold 70. The receptacle portion 32 is configured to define an internal space to seat one or more water treatment components. In the illustrated embodiment, the neck portion 30 is engaged with and extends upwardly from the outer shell 12. As shown in FIG. 2, the neck portion 30 is seated within the top opening 22 on the shoulder 24. The neck portion 30 may be joined to the outer shell 12 using essentially any suitable mechanism, such as adhesive, cement, welding, friction, press fit, fasteners, etc. In the illustrated embodiment, the neck portion 30 includes an outer flange 36 that is configured to seat on shoulder 24. The outer flange 36 of the illustrated embodiment extends around the circumference of the neck portion 30. The neck portion 30 is configured to receive the manifold 70, which closes the inner liner 14. In the illustrated embodiment, a plurality of key tabs 79 extend upwardly from the neck portion 30 to help locate the manifold 70 with respect to the inner liner 14. The key tabs 79 are configured to interfit with corresponding slots 88 in the manifold 70. The number, size, shape and configuration of key tabs 79 and slots 88 may vary from application to application, and may be deleted when not desired. In the illustrated embodiment, the manifold 70 is secured in place on the neck portion 30 by the outer ring 80. In the illustrated embodiment, the neck portion 30 includes outer threads 38 configured to mate with inner threads 86 on the interior of the outer ring 80. The receptacle portion 32 is configured to extend down into the outer shell 12 and to provide an interior space 34 suitable for receiving and housing the water treatment components.

In the illustrated embodiment, the bottom of the inner liner 14 is formed with a base 18 configured to provide a stable base 18 for the water treatment component(s) disposed within the receptacle portion 32, such as a carbon block and UV lamp assembly. The base 18 of the illustrated embodiment is configured to be at uniform distance from the top of the inner liner 14 to facilitate proper support of the water treatment component. For example, with the water treatment assembly described above (e.g. assembly of carbon block filter and UV lamp), the pressure vessel 10 is configured to compress the water treatment assembly between the manifold 70 and the base 18 with an appropriate amount of force to create any desired watertight seals at the interface between the water treatment assembly and the manifold 70 and the interface between the water treat assembly and the base 18. In the illustrated embodiment, the base 18 is configure to receive the described water treatment assembly, but the base 18 may be configured to receive other water treatment components. As perhaps best shown in FIG. 12-13, the base 18 of the illustrated embodiment is formed in the bottom of the inner liner 14 by a central planar section 19 that is surrounded by a plurality of contours 21. In this embodiment, the planar section 19 and contours 21 cooperative form a support surface of the water treatment component. For example, the bottom of the inner liner 14 may be formed into a petaloid shape akin to the bottom of a plastic soft drink, or water, bottle. The top surfaces of the petaloid elements may cooperative with the planar section 19 to support the bottom of the water treatment component. Additionally, the contours may help to strengthen the inner liner 14. In the embodiment of FIGS. 1-13, the contours forming the base 18 are configured to interfit with the corresponding support features (e.g. support ribs 28) in the outer shell 12. More specifically, the planar section 19 may engage the central portion of the support ribs 28 and the petaloid contours 21 may extend down into the spaces between the radially-spaced groups of support ribs 28. In the embodiment of FIGS. 14-15, the outer shell 12′ does not include support features and the inner liner 14′ may directly engage the bottom cover 40′. The size, shape and configuration of the base 18 may be varied to accommodate the desired water treatment component(s).

The inner liner 14 may be manufactured from a wide range of materials. In the illustrated embodiment, the inner liner 14 is manufactured from PET, PETG or other thermoplastic materials having acceptable non-leaching characteristics. The inner liner 14 may be manufactured using any suitable techniques and apparatus. In the illustrated embodiment, the inner liner 14 is blow molded using generally conventional blow molding techniques and apparatus. The inner liner 14 of this embodiment is manufactured from a preform (or blank) that is injection molded or otherwise formed from the desired material. The blow molding process may occur within the outer shell 12 or outside the outer shell 12. For example, the receptacle portion 32 of the inner liner 14 may be blow molded into the interior of the outer shell 12. In the illustrated embodiment, the preform (not shown) is injection molded to form a neck portion 30 injection in the desired finished shape and a receptacle portion 32 in a rudimentary form that it can be blow molded into its finished shape. The inner liner preform may be situated inside the outer shell 12 and then blow molded outwardly and downwardly in a generally conventionally manner using conventional blow molding techniques and apparatus. More specifically, the neck portion of the preform may be secured to the outer shell 12 with the rudimentary receptacle portion extending down into the interior space 20. The receptacle portion 32 may then be heated to the desired temperature and the interior of the receptacle portion 32 may be subject to pressurized fluid, such as air, which expands the rudimentary receptacle portion 32 into the desired shape. In addition (or as an alternative) to internal pressure, reduced pressure may be applied to the exterior of the receptacle portion 32, which may draw or assist in drawing the receptacle portion 32 outwardly to the desired finished shape. The receptacle portion 32 may be configured to engage and possibly mechanically interlock with the outer shell 12 as it is blow molded into its final shape. Additionally or alternatively, the inner liner 14 may be cemented, heat welded, mechanically interlocked or otherwise interconnected with the outer shell. In the embodiment of FIGS. 14-15, the inner liner 14′ is, at ambient pressure, spaced apart from the outer shell 12′ so that the inner liner 14′ can expand under pressure into the space provided by the outer shell 12′. This may occur as an inherent part of the blow molding process. For example, the receptacle portion 32 may be blow molded outwardly into contact with the outer shell, but it may shrink somewhat afterward to create a gap therebetween. As another example, blow molding may be controlled so that expansion of the receptacle portion 30 stops before contact is made with the outer shell 12. As noted above, the outer shell 12′ may include one or more features on its inner surface to maintain the desired gap between the inner liner 14′ and the outer shell 12′. For example, the outer shell 12′ may, as noted above, include a plurality of ribs 16a-d′ extending inwardly from the inner surface of the outer shell 12′ toward the inner liner 14′. The inner liner 14′ may, as noted above, include corresponding channels 52a-c′ that align with the ribs 16a-d′. The ribs 16a-d′ may help to ensure that a gap remains between the receptacle portion 32 and the outer shell 12 during blow molding and afterward during use of the water treatment system.

In the illustrated embodiment, the inner liner 14′ is configured so that the neck portion 30′ has sufficient structural integrity to receive the manifold 70 and the outer ring 80. To meet this objective, the neck portion 30′ may be manufactured with sufficient wall thickness to withstand the anticipated water pressures without material change in size. In the illustrated embodiment, the receptacle portion 32′ is configured so that after it has been blow molded into its final shape, the receptacle portion 32′ is capable of flexing, but not rupturing under the range of anticipated water pressures. In some applications, the outer shell 12′ may reinforce and provide supplemental hoop strength to the inner liner 14′ once the inner liner 14′ has expanded into contact with the ribs 16a-d and/or the interior surface of the outer shell 12′. In the illustrated embodiment, the pressure vessel 10, 10′ is designed to function with operating pressures in the range of 15 to 125 psi, but this range is merely exemplary and the pressure vessel may be readily adapted to other operating pressure ranges. As a practical matter, the pressure vessel may be configured to withstand pressure that is significantly greater than the rated pressure. For example, with the illustrated embodiment, it may be desirable to configure the pressure vessel to withstand at least three times the rated pressure (or 375 psi).

In the illustrated embodiment, the pressure vessel 10 includes a manifold 70. The manifold 70 is generally circular and is configured to close the inner liner 14 and to provide a water inlet 76 and a water outlet 78 for attaching water connections to the pressure vessel 10. In the illustrated embodiment, the manifold 70 includes a generally disc shaped main body 72 having a central hub 74 that extends upwardly from the center of the main body 72 to accommodate the UV lamp (as described in more detail below). The manifold 70 may include a perimeter seal 75 configured to engage the top edge of the neck portion 30 (See, e.g., FIG. 15). In use, the perimeter seal 75 may provide a leaktight seal between the manifold 70 and the inner liner 14. Alternatively (or additionally), a perimeter seal (not shown) may be provided on the top edge of the inner liner 14. As noted above, the manifold 70 may define slots 88 that interfit with tabs 79 in the inner liner 14 to facilitate proper alignment between the manifold 70 and the inner liner 14. The design and configuration of the manifold 70 may vary from application to application, for example, to accommodate different water treatment components.

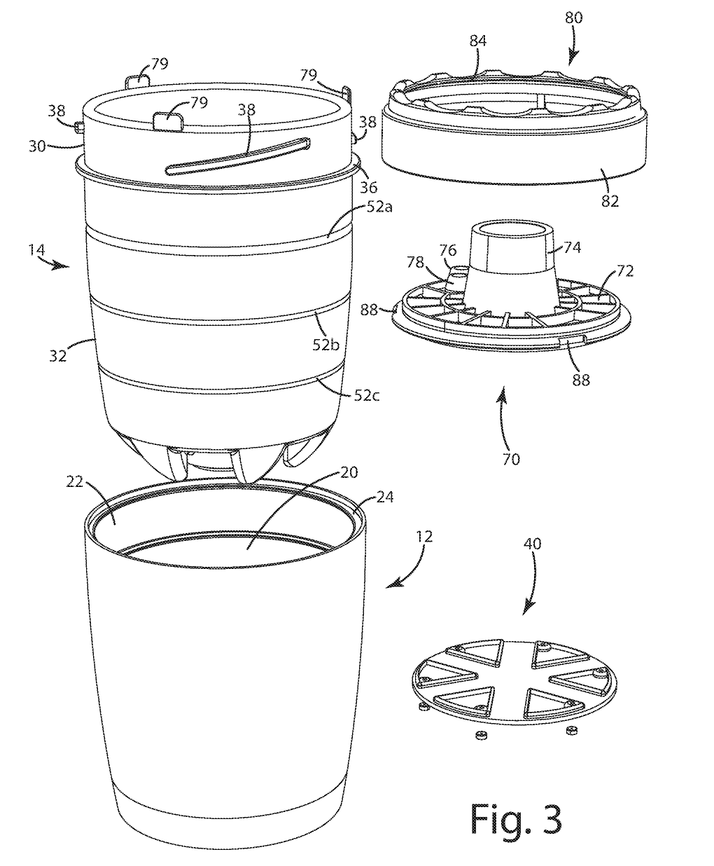

In the illustrated embodiment, the manifold 70 is secured to the inner liner 14 by an outer ring 80. Referring now to FIGS. 3 and 4, the outer ring 80 of the illustrated embodiment is an annular structure that has generally inverted L-shape when view in cross-section. More specifically, the outer ring 80 generally includes a vertical wall 82 and a horizontal flange 84. The vertical wall 82 is configured to fit about the upper end of the neck portion 30 and includes internal threads 86 that are configured to threadedly interact with the external threads 38 on the neck portion 30. The horizontal flange 84 extends inwardly from the top edge of the vertical wall 82 and is configured to engage the upper surface of the manifold 70 around its perimeter. The outer ring 80 is merely exemplary and may be replaced by other structure suitable for interconnecting the manifold 70 and the neck portion 30, such as other types of connecting structures or one or more fasteners. In some applications, the manifold may be configured to directly attach the neck portion 30 without the need for an outer ring 80 or other intermediate connecting structure. For example, the manifold 70 may be provide with a threaded connecting structure configured to threadedly engage with the threads 38 on the exterior the neck portion 30.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A pressure vessel for a water treatment system comprising:
an outer shell; and
a blow-molded inner liner disposed within said outer shell, said inner liner having a mouth portion and a receptacle portion, said receptacle portion configured to receive a water treatment device and define at least a portion of a water flow path associated with the water treatment device, said inner liner lining said outer shell such that said outer shell does not come into contact with water passing through the water flow path or the water treatment device.

2. The pressure vessel of claim 1 wherein said inner liner is configured to flex outwardly under water pressures.

3. The pressure vessel of claim 2 wherein the outer shell is configured with sufficient structural rigidity to reinforce the inner liner and to provide the pressure vessel with dimensional stability under anticipated water pressures.

4. The pressure vessel of claim 3 wherein the outer shell includes at least one support features extending inwardly toward said inner liner, said support feature configured to potentially engage said inner liner.

5. The pressure vessel of claim 4 wherein said at least one support feature includes at least one inwardly extending rib.

6. The pressure vessel of claim 3 wherein the outer shell includes at least one base support feature configured to support a base of said inner liner.

7. The pressure vessel of claim 1 wherein said inner liner has a petaloid base.

8. The pressure vessel of claim 7 wherein said petaloid base is in direct contact with said outer shell.

9. The pressure vessel of claim 7 wherein said petaloid base includes a central planar section.

10. The pressure vessel of claim 1 wherein said outer shell includes a one-way valve configured to allow air to be expelled from between said outer shell and said inner liner when said inner liner is blow molded in place within said outer shell.

11. A pressure vessel for containing a water treatment component of a water treatment system comprising:
an outer shell defining an internal space, said outer shell being rigid and having an open end;
an inner liner disposed within said outer shell, said inner liner having a rigid neck portion supported by said outer shell about said open end and a flexible receptacle portion extending from said neck portion into said internal space, said neck portion defining a neck opening; said receptacle portion configured to receive a water treatment component, said inner liner lining said outer shell such that said outer shell does not come into contact with water passing through the water treatment system; and
a manifold closing said neck portion, said manifold having a water inlet and a water outlet.

12. The pressure vessel of claim 11 wherein said outer shell includes a closed end opposite said open end.

13. The pressure vessel of claim 12 wherein said closed end is a cover plate secure to said outer shell.

14. The pressure vessel of claim 12 wherein said closed end includes a valve.

15. The pressure vessel of claim 11 wherein said inner liner includes a contoured base defining a pedestal to support a water treatment component.

16. The pressure vessel of claim 15 wherein said contoured base is petaloid and include a central section surrounded by a plurality of radially symmetric lobes.

17. The pressure vessel of claim 11 wherein said outer shell includes a plurality of support features extending into said internal space between said outer shell and said inner liner.

18. The pressure vessel of claim 15 wherein said outer shell includes at least one pedestal support feature disposed opposite said open end to support said pedestal of said inner liner.

19. A pressure vessel for a water treatment system comprising:
an outer shell having an open end and a closed end;
an inner liner coupled to said outer shell, said inner liner having a rigid neck portion and a flexible receptacle portion, said neck portion disposed adjacent said outer shell outside said internal space, said neck portion having a neck opening through which a water treatment component may be fitted into said receptacle portion; said receptacle portion disposed in said internal space in spaced relationship with said outer shell to define an enclosed space between said outer shell and said inner liner, said enclosed space being at a partial vacuum; and
a manifold closing said neck opening; and
a closure securing said manifold to said neck portion of said inner part.

20. The pressure vessel of claim 19 wherein said outer shell includes support features extending into said enclosed space to maintain a gap between said outer shell and said inner liner.

21. The pressure vessel of claim 20 wherein said inner liner a contoured base defining a pedestal to support a water treatment component, said contoured base being petaloid and including a central planar section surrounded by a plurality of radially symmetric lobes.

22. A method for forming a blow molded pressure vessel, comprising the steps of:
positioning an inner liner blank within an outer shell, the outer shell defining at least one opening;
inserting a mandrel into the opening in the outer shell;
blow molding the inner liner blank in place within the outer shell to form an inner liner, at least a portion of the inner liner blank engaging at least a portion of the mandrel during said blow molding step, whereby the mandrel assists in forming at least a portion of the inner liner; and
withdrawing the mandrel from the opening after said blow molding step leaving the inner liner in place within the outer shell.

23. The method of claim 22 wherein the liner blank includes neck portion and a receptacle portion, said blow molding step including blow molding the receptacle portion into a desired shape.

24. The method of claim 23 wherein the outer shell includes a plurality of inwardly extending ribs; and
wherein said blow molding step includes blow molding the inner liner blank outwardly into contact with at least one of the ribs.

25. The method of claim 24 further including the step of closing the opening in the outer shell with a cover following said blow molding step.

26. The method of claim 25 wherein the outer shell includes a plurality of support ribs disposed adjacent to the opening to support the inner liner; and
wherein the mandrel includes at least one lobe extending between adjacent support ribs when the mandrel is disposed in the opening.

27. The method of claim 26 further including the step of partially evacuating a space between the inner liner and the outer shell.
